(19) United States
(12) Patent Application Publication
(10) Pub. No.: US 2014/0067999 A1
(43) Pub. Date: Mar. 6, 2014

(54) SYSTEM AND METHOD FOR MANAGING LOAD OF VIRTUAL MACHINES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); KUAN-CHIAO PENG, New Taipei (TW); YEN-HUNG LIN, New Taipei (TW)

(73) Assignee: HON HAI PRECISION INDUSTRY CO., LTD., New Taipei (TW)

(21) Appl. No.: 13/965,229

(22) Filed: Aug. 13, 2013

(30) Foreign Application Priority Data
Aug. 31, 2012 (TW) 101131671

(51) Int. Cl. H04L 29/08

(52) U.S. Cl. CPC H04L 67/1012
USPC 709/217

(57) ABSTRACT

A method for a first server to manage load of virtual machines in more than one second server, the method collects resource usage rates of each second server and stores the collected resource usage rates into a preset table according to an identity (ID) of each second server. When the resource usage rates of a second server match a critical condition, the method marks the second server. A target server and one or more target virtual machines are determined and the method transfers the determined target virtual machine(s) into the target server.

### BACKGROUND

1. Technical Field

Embodiments of the present disclosure relate to virtual machines management technology, and particularly to a system and a method for managing load of virtual machines.

2. Description of Related Art

Users can use virtualization technology (e.g. virtualized software) of virtual machines to accomplish operations of a plurality of physical host computers. However, because the virtualization technology has specialties of flexible resource configurations and rapid deployments, usage rates of hardware resources increase. Furthermore, when a warning of excessive load is received, response time for transferring virtual machines to another host computer needs to be short. Therefore, it is very important to balance load of each virtual machine to achieve optimal configuration of the hardware resources. An existing method to balance resource loads is to compare load rates between a source virtual machine and an adjacent virtual machine. Although the existing method can improve the response speed, utilization of optimal resource cannot be achieved. For example, some idle virtual machines far away from the source computer may not be used.

### BRIEF DESCRIPTION OF THE DRAWINGS

FIG. 1 is a schematic diagram of one embodiment of a load management system in a first server.

FIG. 2 is a block diagram of one embodiment of function modules of the load management system in the first server in FIG. 1.

FIG. 3 is flowchart illustrating one embodiment of a method for managing load of virtual machines.

FIG. 4 is a schematic diagram illustrating one embodiment of a method for calculating an average usage rate of each second server.

FIG. 5 is a schematic diagram illustrating one embodiment of a method for finding a target server having a usage rating matched a preset condition from second server.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

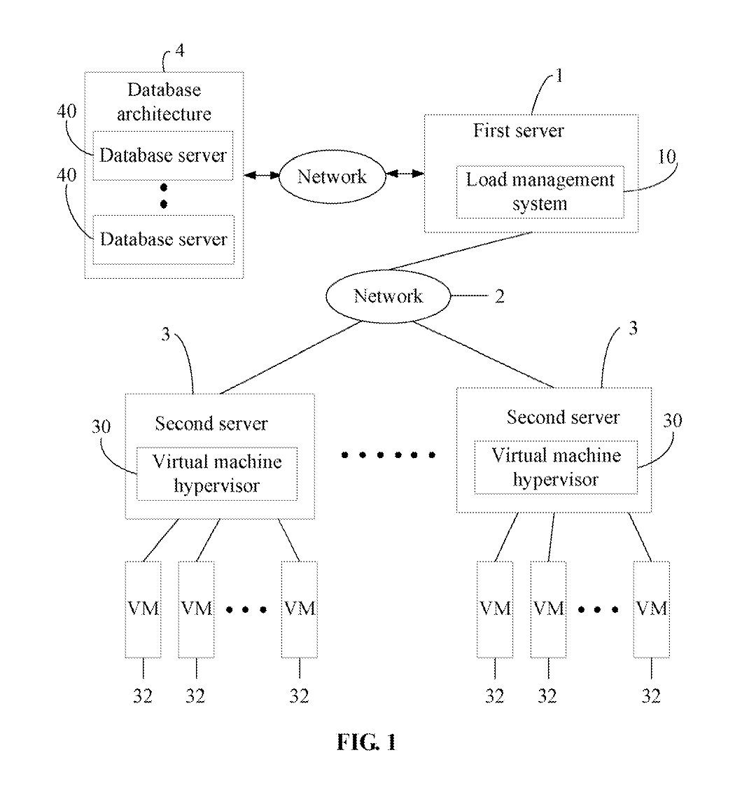

FIG. 1 is a schematic diagram of one embodiment of a load management system 10 in a first server 1. The first server 1 communicates with a plurality of second servers 3 (two second servers are shown in FIG. 1) through a network 2. Each of the second servers 3 monitors and manages one or more virtual machines 32 through a virtual machine hypervisor 30 installed in each of the second servers 3. In one embodiment, the first server 1 is a control server or a host computer for controlling and managing the second servers 3 and all the virtual machines 32 monitored by the second servers 3. The virtual machine hypervisor 30 in each second server 3 monitors resource usage rates of each of the virtual machines 32.

The first server 1 further communicates with a database architecture 4 through the network 2. The database architecture 4 may be Non-relational SQL (NoSQL) database systems. The database architecture 4 includes at least one database servers 40 (two master database serves are shown). The database servers 40 stores and operates data.

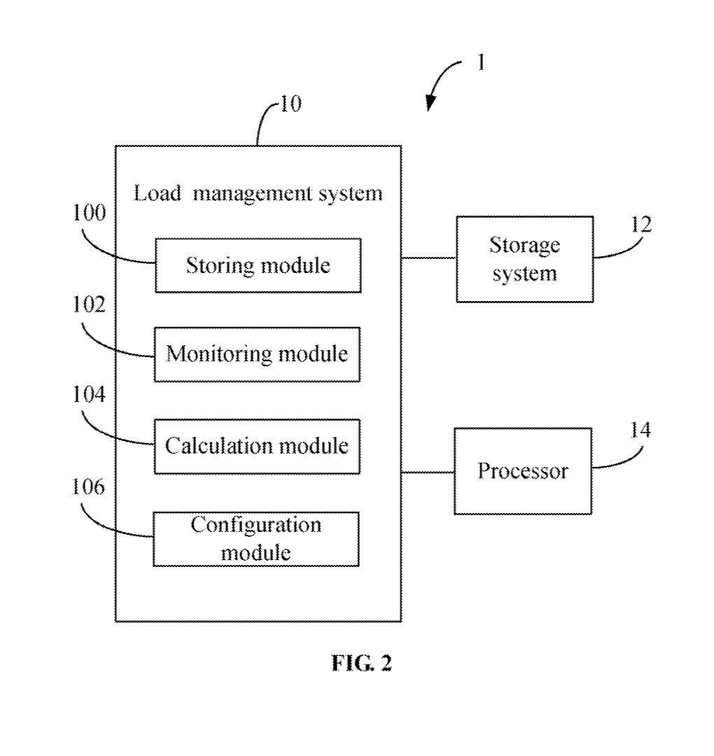

FIG. 2 is a block diagram of one embodiment of function modules of the load management system 10 in the first server 1 in FIG. 1. The first server 1 further includes a storage system 12 and at least one processor 14. The storage system 12 may be a memory (e.g., random access memory, flash memory, hard disk drive) of the first server 1. The at least one processor 14 executes one or more computerized codes and other applications of the electronic device 1, to provide functions of the load management system 10.

In one embodiment, the load management system 10 includes a storing module 100, a monitoring module 102, an operation module 104, and a configuration module 106. The modules 100, 102, 104, and 106 comprise computerized codes in the form of one or more programs that are stored in the storage system 12. The computerized codes include instructions that are executed by the at least one processor 14 to provide functions for the modules.

The storing module 100 collects resource usage rates of each of the second servers 3 at each predetermined time interval (e.g. 5 minutes), and stores the collected resource usage rates into a preset table according to an identity (ID) of each of the second servers 3. In one embodiment, the resource usage rates include a central processing unit (CPU) usage rate and a memory (MEM) usage rate. The preset table corresponding to each of the second servers 3 may include, but is not limited to, the ID, the CPU usage rate, and the MEM usage rate of each of the second servers 3, and a timestamp for the storage of the resource usage rates of each of the second servers 3 into the preset table.

The preset table for the second servers 3 is stored into a specified database server 40 in the database architecture 4. For example, one or more second servers 3 may correspond to a specified database server 40.

The monitoring module 102 monitors the resource usage rates of each of the second servers 3 in real-time. When resource usage rates of one of the second servers 3 match a critical condition, the monitoring module 102 marks the second server 3. In one embodiment, the critical condition may include a first threshold value of CPU usage rate, a second threshold value of MEM usage rate, and a preset time duration (e.g. 1 hour). If CPU usage rates of a second server 3 acquired during the preset time duration are greater than or equal to the first threshold value (e.g. 80%) and MEM usage rates of the second server 3 acquired during the preset time duration are greater than or equal to the second threshold value (e.g. 70%), the monitoring module 102 determines that the second server 3 matches the critical condition. In other embodiments, the critical condition may merely include the preset time duration, and one of the first threshold value and the second threshold value.

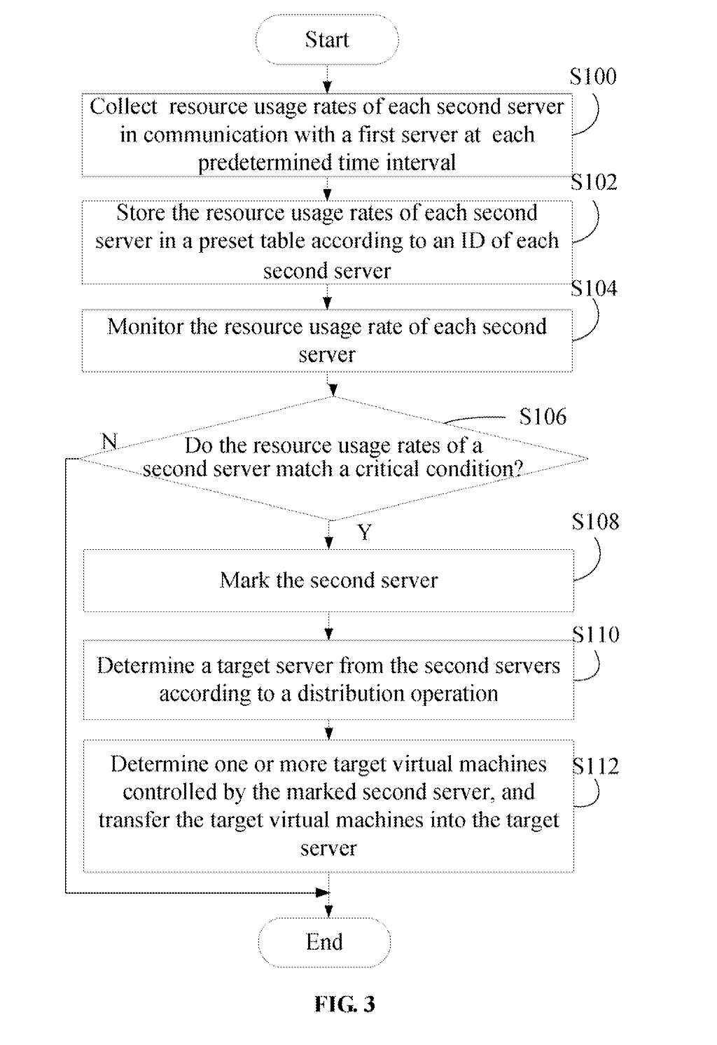

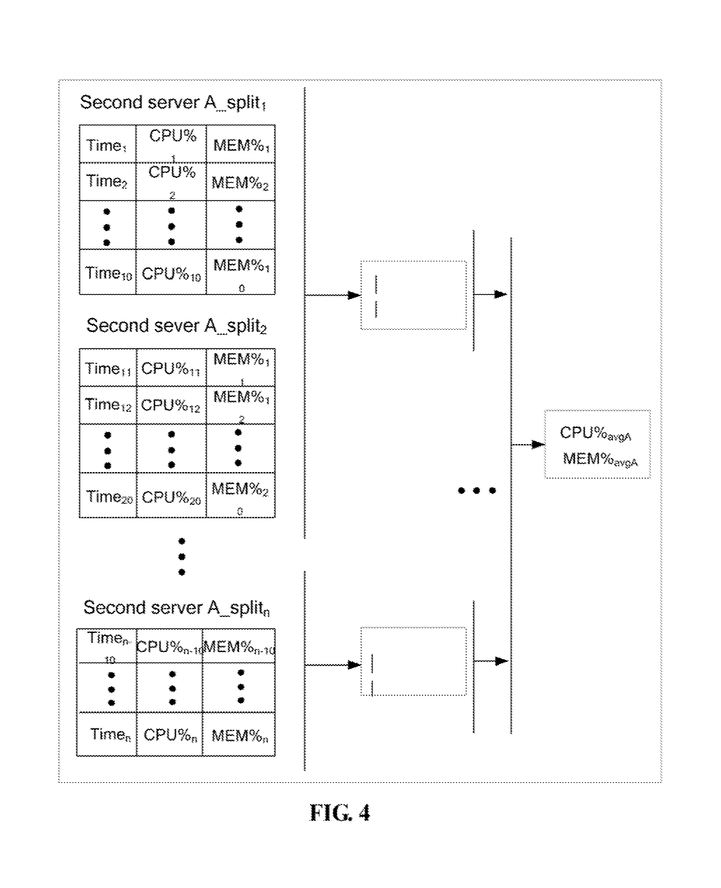

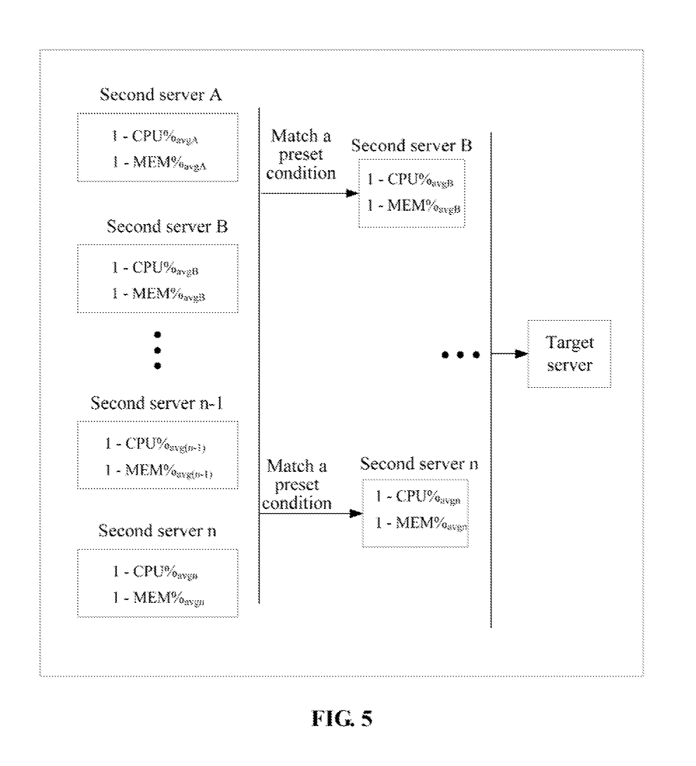

Once one of the second servers 3 has been marked, the operation module 104 determines a target server from the second servers 3 according to a distribution operation. The resource usage rates of the target server matches a preset rule. Details of determining the target server are given in FIG. 3, FIG. 4, and FIG. 5.

The configuration module 106 determines one or more target virtual machines from all the virtual machines 32 managed by the marked second server 3, and transfers the determined target virtual machines into the target server. In one embodiment, the determined target virtual machines have the minimum resource usage rates among all the virtual machines 32 managed by the marked second server 3. In other embodiments, the configuration module 106 may select one or more virtual machines 32 randomly to be the target virtual machines.

FIG. 3 is flowchart illustrating one embodiment of a method for managing load of virtual machines. Depending on the embodiment, additional steps may be added, others deleted, and the ordering of the steps may be changed.

In step S100, the storing module 100 collects resource usage rates of each of the second servers 3 at each predetermined time interval (e.g. 5 minutes). In one embodiment, the resource usage rates include a CPU usage rate and a MEM usage rate.

In step S102, the storing module 100 stores the collected resource usage rates into a preset table according to an ID of each of the second servers 3. The preset table for each of the second servers 3 may include, but is not limited to, the ID, the CPU usage rate, and the MEM usage rate of the each of the second servers 3, and a timestamp of storing the resource usage rates of each of the second servers 3 into the preset table. As shown in FIG. 4, the preset table includes an ID “second server A” of one second server 3, a CPU usage rate “CPU %₁” and a MEM usage rate “MEM %₁” corresponding to a timestamp “Time₁”. The preset table for each of the second servers 3 is stored into a specified database server 40 in the database architecture 4.

In step S104, the monitoring module 102 monitors the resource usage rates of each of the second servers 3 in real-time.

In step S106, the monitoring module 102 determines whether the resource usage rates of one second servers 3 match a critical condition. As mentioned above, the critical condition may include a first threshold value of CPU usage rate, a second threshold value of MEM usage rate, and a preset time duration. When the resource usage rates of one of the second servers 3 match the critical condition, step S108 is implemented. When no resource usage rates of the second servers 3 matches the critical condition, the procedure ends.

In step S108, the monitoring module 102 marks the second server 3 having the resource usage rates which match the critical condition.

In step S110, the operation module 104 determines a target server from the second servers 3 according to a distribution operation. In one embodiment, the distribution operation includes a calculation step for calculating average usage rates of each of the second servers 3, and a determination step for determining the target server.

The operation module 104 first divides the preset table of each of the second servers 3 into a plurality of segments by a preset number of the timestamps. As shown in FIG. 4, the preset table of the second server “A” is divided into the segments of “split₁”, “split₂”, . . . , and “split,” by ten times of the timestamps. The preset number may be determined according to a number of the database servers 40 and a total number of the timestamps in the preset table. For example, if the total number of timestamps is forty and there are five database servers 40, the preset number may be equal to 8.

The operation module 104 distributes each segment of the preset table to the database servers 40 to calculate a first sum of the CPU usage rates and a second sum of the MEM usage rate of each segment. The operation module 104 obtains a first total sum by merging first sums of all the segments of each of the second servers 3, and obtains a second total sum by merging second sums of all the segments of each of the second servers 3. The operation module 104 obtains average usage rates of each of the second servers 3 by dividing the first total sum by a number of the segments and dividing the second total sum by the number of the segments. The average usage rates include an average CPU usage rate (e.g. “CPU %_{avgA}” as shown in FIG. 4) and an average MEM usage rate (“MEM %_{avgA}” as shown in FIG. 4).

When the average usage rates of all the second servers 3 have been obtained, the operation module 104 compares the average usage rates of all the second servers 3, and determines matched second servers 3 which have average usage rates which match a preset condition. The preset condition may include a third threshold value of CPU usage rate and a fourth threshold value of MEM usage rate. If a CPU average usage rate of a second server 3 is lower than or equal to a third threshold value (e.g. 20%) and a MEM average usage rate of the second server 3 is lower than or equal to a fourth threshold value (e.g. 40%), the average usage rates of the second server 3 is determined to match the preset condition. When all matched second servers 3 have been determined, the operation module 104 determines a matched second server 3 having a minimum CPU usage rate to be the target server. In another embodiment, the operation module 104 may determine the target server randomly among the matched second servers 3. If there is no matched second server 3, the operation module 104 determines the target server which has the average usage rates with the closest approximation to the preset condition.

In step S112, the configuration module 106 determines one or more target virtual machines from all the virtual machines 32 managed by the marked second server 3, and transfers the determined target virtual machine(s) into the target server. In one embodiment, the determined target virtual machine(s) have the minimum resource usage rates among all the virtual machines 32 managed by the marked second server 3.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for managing load of virtual machines in a first server, the first server being in communication with second servers, the method comprising:
collecting resource usage rates of each of the second servers at each predetermined time interval, and storing the collected resource usage rates into a corresponding preset table according to an identity (ID) of each of the second servers;
when resource usage rates of one of the second servers matches a critical condition, marking the second server;
determining a target server from the second servers according to a distribution operation; and
determining one or more target virtual machines managed by the marked second server, and transferring the determined target virtual machines into the target server.

2. The method as described in claim 1, wherein the resource usage rates comprise a central processing unit (CPU) usage rate and a memory (MEM) usage rate, and the preset table corresponding to each of the second servers comprises the ID, the CPU usage rate, and the MEM usage rate of each of the second servers, and a timestamp of storing the resource usage rates of each of the second servers into the preset table.

3. The method as described in claim 2, wherein the critical condition comprises a first threshold value of CPU usage rate, a second threshold value of MEM usage rate, and a preset time duration.

4. The method as described in claim 2, wherein the step of determining a target server from the second servers according to the distribution operation comprises:
dividing the preset table of each of the second servers into segments;
calculating a sum of the resource usage rates of each of the segments by distributing each of the segments of the preset table to database servers in communication with the first server;
obtaining a total sum of the resource usage rates of each of the second servers by merging the sums of all the segments;
obtaining average usage rates of each of the second servers by dividing the total sum by a number of the segments;
when the average usage rates of all the second servers have been obtained, comparing the average usage rates of the second servers, and determining matched second servers having the average usage rates matched a preset condition;
when all the matched second servers have been determined, determining a second server having a minimum CPU usage rate to be the target server.

5. The method as described in claim 4, wherein the preset condition comprises a third threshold value of CPU usage rate and a fourth threshold value of MEM usage rate.

6. The method as described in claim 2, wherein the determined target virtual machines have minimum resource usage rates among virtual machines in the marked second server.

7. A first server for managing load of virtual machines in a first server, the first server in communication with second servers, the first server comprising:
at least one processor; and
a computer-readable storage medium storing one or more programs, which when executed by the at least one processor, the one or more programs comprising causes the at least one processor to:
collect resource usage rates of each of the second servers at each predetermined time interval, and store the collected resource usage rates into a corresponding preset table according to an identity (ID) of each of the second servers;
when resource usage rates of one of the second servers matches a critical condition, mark the second server;
determine a target server from the second servers according to a distribution operation; and
determine one or more target virtual machines managed by the marked second server, and transfer the determined target virtual machines into the target server.

8. The first server as described in claim 7, wherein the resource usage rates comprise a central processing unit (CPU) usage rate and a memory (MEM) usage rate, and the preset table corresponding to each of the second servers comprises the ID, the CPU usage rate, and the MEM usage rate of each of the second servers, and a timestamp of storing the resource usage rates of each of the second servers into the preset table.

9. The first server as described in claim 8, wherein the critical condition comprises a first threshold value of CPU usage rate, a second threshold value of MEM usage rate, and a preset time duration.

10. The first server as described in claim 8, wherein the target server is determined according to the distribution operation by:
dividing the preset table of each of the second servers into segments;
calculating a sum of the resource usage rates of each of the segments by distributing each of the segments of the preset table to database servers in communication with the first server;
obtaining a total sum of the resource usage rates of each of the second servers by merging the sums of all the segments;
obtaining average usage rates of each of the second servers by dividing the total sum by a number of the segments;
when the average usage rates of all the second servers have been obtained, comparing the average usage rates of the second servers, and determining matched second servers having the average usage rates matched a preset condition;
when all the matched second servers have been determined, determining a second server having a minimum CPU usage rate to be the target server.

11. The first server as described in claim 10, wherein the preset condition comprises a third threshold value of CPU usage rate and a fourth threshold value of MEM usage rate.

12. The electronic device as described in claim 8, wherein the determined target virtual machines have minimum resource usage rates among all the virtual machines managed by the marked second server.

13. A non-transitory computer readable storage medium having stored thereon instructions that, when executed by a processor of a first server, causes the first server to perform a method for managing load of virtual machines in a first server, the first server in communication with second servers, the method comprising:
collecting resource usage rates of each of the second servers at each predetermined time interval, and storing the collected resource usage rates into a corresponding preset table according to an identity (ID) of each of the second servers;
when resource usage rates of one of the second servers matches a critical condition, marking the second server;
determining a target server from the second servers according to a distribution operation; and
determining one or more target virtual machines managed by the marked second server, and transferring the determined target virtual machines into the target server.

14. The non-transitory computer readable storage medium as described in claim 13, wherein the resource usage rates comprise a central processing unit (CPU) usage rate and a memory (MEM) usage rate, and the preset table corresponding to each of the second servers comprises the ID, the CPU usage rate, and the MEM usage rate of each of the second servers, and a timestamp of storing the resource usage rates of each of the second servers into the preset table.

15. The non-transitory computer readable storage medium as described in claim 14, wherein the critical condition comprises a first threshold value of CPU usage rate, a second threshold value of MEM usage rate, and a preset time duration.

16. The non-transitory computer readable storage medium as described in claim 14, wherein the step of determining the target server according to the distribution operation comprises:
dividing the preset table of each of the second servers into segments;
calculating a sum of the resource usage rates of each of the segments by distributing each of the segments of the preset table to database servers in communication with the first server;
obtaining a total sum of the resource usage rates of each of the second servers by merging the sums of all the segments;
obtaining average usage rates of each of the second servers by dividing the total sum by a number of the segments;
when the average usage rates of all the second servers have been obtained, comparing the average usage rates of the second servers, and determining matched second servers having the average usage rates matched a preset condition;
when all the matched second servers have been determined, determining a second server having a minimum CPU usage rate to be the target server.

17. The non-transitory computer readable storage medium as described in claim 16, wherein the preset condition comprises a third threshold value of CPU usage rate and a fourth threshold value of MEM usage rate.

18. The non-transitory computer readable storage medium as described in claim 14, wherein the determined target virtual machines have minimum resource usage rates among all the virtual machines managed by the marked second server.
